(19) United States
(12) Patent Application Publication
(10) Pub. No.: US 2014/0129179 A1
(43) Pub. Date: May 8, 2014

(54) SYSTEM AND APPARATUS FOR MULTI CHANNEL GLOSS MEASUREMENTS

(71) Applicant: Datacolor, Inc., Lawrenceville, NJ (US)

(72) Inventors: Zhiling Xu, Princeton Junction, NJ (US); Michael H. Brill, Kingston, NJ (US)

(73) Assignee: Datacolor, Inc., Lawrenceville, NJ (US)

(21) Appl. No.: 14/075,722

(22) Filed: Nov. 8, 2013

Related U.S. Application Data
(60) Provisional application No. 61/724,057, filed on Nov. 8, 2012.

(51) Int. Cl. G01N 21/57

(52) U.S. Cl. CPC G01N 21/57
USPC 702/189; 356/448

(57) ABSTRACT

The present invention is directed to an apparatus and method for determining a set of gloss measurement values of a sample to be measured. The invention includes a plurality of light sources having a light output, the plurality of sources configured to project light in the direction of a single sample having a gloss characteristic to be measured, wherein the planes of incidence of the light sources are arrayed at different azimuthal angles about the perpendicular direction of the sample. Furthermore, the invention includes a plurality gloss-sensitive sensors, each positioned at 180 degrees of azimuthal angle from the plurality of light sources so as to receive light reflected off a sample and output a plurality of measured gloss sample channel values and a processor configured to compare the outputs of the plurality of sample channel values and generate a plurality of angle-indexed gloss measurement values.

### CROSS-REFERENCE TO RELATED APPLICATIONS

This application claims the benefit of priority under 35 U.S.C. Section 119(e) of U.S. Application Ser. No. 61/724,057, filed Nov. 8, 2012, which is hereby incorporated by reference in its entirety.

### FIELD OF THE INVENTION

The present invention relates an apparatus and system for determining the gloss measurement value of a sample using a multi-channel gloss meter. More particularly the apparatus relates to the operation of a multi-channel gloss meter equipped with a plurality of gloss sensors and illuminants configured to simultaneously record gloss values of a single sample at different orientations (azimuthal angles) about the sample normal and generate a gloss value for each orientation.

### BACKGROUND OF THE INVENTION

Gloss is an important quality criterion for assessing the quality of paints, coatings, plastic surfaces and the like. Measuring gloss with results that are repeatable and precise is, however, exceptionally difficult. In its general definition, gloss is the property of a surface regarding its ability to reflect light in a minor-like (specular) direction. Sample surfaces have greater or lesser degrees of anisotropy, whereby the gloss depends on the orientation of the sample about its perpendicular direction. A single gloss measurement will not reveal this anisotropy, nor will it reveal the special direction of greatest gloss. For these reasons conventional gloss meters (which have a single plane of incidence) have difficulty quantifying the gloss of anisotropic surfaces. Adding to the complications, the light used to measure gloss is itself imprecise. The characteristics of light render the intensity of the reflected light subject to variations due to voltage or frequency changes, as well as localized moisture or other atmospheric conditions. The physical dimensions of a sample combined with the inconsistent intensity of the light sources make it difficult to standardize gloss measurements across samples. As well, considerable physical deviations within a sample make it difficult to standardize the results of gloss measurements.

Furthermore, with high gloss surfaces, the angle of reflection equals the angle of incidence of the incoming light. Thus, the light reflected off the surface is reflected along the same angle as the incoming light, on the opposite side of the perpendicular ray from the surface. However, the more complex the shape, the more difficult it is to accurately measure gloss. Considerable physical deviations within a sample, such as one with an anisotropic surface, make it difficult to standardize the results of gloss measurements. For example, for an anisotropic surface it is difficult to standardize the angle of rotation of the measurement instrument about the surface normal. Conventional gloss-meters and gloss-measurement devices are not fully equipped to overcome this difficulty in measurement precision.

There have been many attempts to develop gloss meters designed to overcome some of the difficulties outlined above. Commonly owned, co-pending U.S. Application 61/666,539 filed on Jun. 25, 2012, hereby incorporated by reference, provide for various aspects and conventions of gloss meters and is configured to provide increased measuring resolution and accuracy.

Gloss meters, such as that described in commonly owned, co-pending application Ser. No. 13/327,072 filed on Dec. 15, 2011, hereby incorporated by reference, are configured to measure and display the results of a technical analysis of the gloss characteristics of a surface. However, standard gloss meters described is equipped with a single gloss meter sensor.

U.S. Pat. No. 8,130,377 to Ingleson, which is hereby incorporated by reference, provides a spectral measurement device that includes a gloss measurement option. The reference provides for a spectrometer using a 45°/0° or sphere based color measurement instrument, while including a separate 60° gloss measurement channel. This measurement channel is separated from the main spectral measurement devices. Additionally, the gloss measurement device can only be operated while the spectral device is not engaged. Furthermore, Ingleson fails to compensate for the inherent variability in the light source. Finally, there is only one gloss channel, and hence the orientation of an anisotropic surface about its surface normal will not be revealed or compensated by the measurement geometry.

U.S. Pat. No. 5,401,977 to Schwarz, which is hereby incorporated by reference, is directed to a manual measurement of a gloss sample designed to achieve a suitable compensation factor. The apparatus and system described are not configured to use a reference channel to automatically calibrate the sample using the light channel of a spectrophotometer. Additionally, the Schwarz reference fails to compensate for thermal and other light quality drifts in the light source.

U.S. Pat. No. 5,377,000 to Berends, which is hereby incorporated by reference, is directed to a gloss measurement system that uses signal value compensation to correct for errors in the measurement. The device of Berends is limited to using two light sources at opposite ends of the visible wavelength spectrum, not a plurality of light sources.

U.S. Pat. No. 6,233,053 to Preston, herein incorporated by reference, is directed to a dual function gloss measurement device. The device of Preston is limited to using multiple light sources to provide corrected gloss values to a measurement device, but fails to provide a multi-channel gloss sensor with gloss values evaluated at different azimuthal angles about the perpendicular (normal) to the sample surface.

The existing prior art devices and methods fail to provide for a single measurement event that provides a highly accurate gloss value across a variety of surface types. Furthermore, the deficiencies in the prior art render measuring gloss complex surfaces difficult and inconsistent, particularly because the anisotropy of the surface is neither revealed nor compensated by the measurement. Therefore, what is needed in the art is a gloss measurement device that provides improved gloss measurement results of a sample with complex surface characteristics. What is also needed in the art is such a device and system that also simplifies and standardizes gloss measurements.

### SUMMARY OF THE INVENTION

In accordance with the broad aspects of the proposed invention, the apparatus and system disclosed herein provides for an improved gloss measurement which overcomes the deficiencies inherent in the prior art. In more particular aspects, the present invention provides a multi-channel gloss meter designed to allow the accurate measurement of gloss values of a variety of surfaces including anisotropic surfaces. In a particular configuration, the apparatus and method so described provides a plurality of gloss meters and illuminants oriented around a sample so as to provide multiple readings of the gloss characteristics of the same sample simultaneously.

A further arrangement of the elements described provides an apparatus with an operational mode configured to provide a reference channel which allows for the compensation of the light-intensity fluctuations of the variety of gloss meter light sources. In further arrangement, the present invention is also directed to a method for determining the gloss characteristics of a surface using a multi-channel gloss sensor array.

### BRIEF DESCRIPTION OF THE DRAWINGS

FIG. 1 is a perspective view of an embodiment of the present invention depicting the multi-channel illuminants and pick-ups.

FIG. 2 is a cut-away side view of one an exemplary light source and its associated illumination tube as described in the present invention.

FIG. 3 is a cut-away side view of an exemplary detector module of the present invention and associated pick up tube.

FIG. 4 is a table depicting the tilt sensitivity of one arrangement of the present invention.

FIG. 5 is a block diagram depicting the connection between the gloss sensor and the processor of the present invention.

FIG. 6 is a chart showing the plotted values of various sensor pairs as provided in one arrangement of the present invention.

### DESCRIPTION OF ILLUSTRATIVE CERTAIN EMBODIMENTS OF THE INVENTION

By way of overview and introduction, the present invention concerns an apparatus and system for the determination of the gloss values of a variety of sample surfaces. The apparatus and system provides a technical solution that enables the improved acquisition of gloss values without the need for multiple reorientations of the sample or the measuring device.

The apparatus described is directed to a device for calibrating and compensating gloss measurement values that result from measuring the gloss of the surface of an object. Those skilled in the art will appreciate those specimens and products that are suitable for gloss measurement.

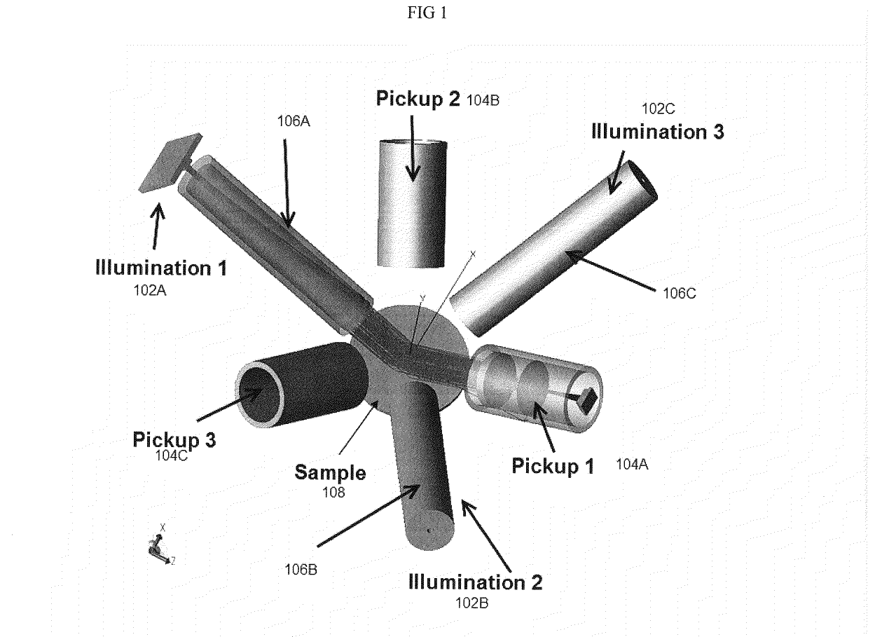

FIG. 1 describes a plurality of light sources 102A, 102B, 102C azimuthally arranged about the normal (perpendicular direction) of the sample to be measured. In the illustrated example, the light sources are orientated 120 degrees from one another. However, those skilled in the art will appreciate that an increase in the number of light sources will necessitate a rebalancing of the spacing between the light sources. The operation of each light source 102 is directed by manual or computer control. In the depicted example, the light source 102 is a single LED (light emitting diode). In an alternative arrangement the LED light source 102 is alternatively one of a plurality of lighting elements selected for use given a desired emission spectrum and intensity characteristics. In the alternative, the gloss light source 102 is a tungsten lighting element or a narrow-band or monochromatic light beam, including laser light. The light source 102 is configured to emit a light beam in the visible or invisible spectrum. Those skilled in the art will appreciate that each of the lighting elements need not be identical. In one arrangement, each illumination source provides a different wavelength or intensity of illumination.

The light sources 102A-C are positioned such that the light output is directed through an illumination tube 106A-C and onto a sample 108. The illumination is then directed to sensors 104 positioned such that the light incident off the sample 108 is reflected to sensors 104 or sensor assemblies that are positioned to intercept the specular reflection corresponding to illumination source 102A-C.

In the illustrated configuration, the sample 108 is a material surface that may be anisotropic. Those skilled in the art will appreciate that the sample 108 can be any material suitable for gloss measurement, regardless of its surface conditions.

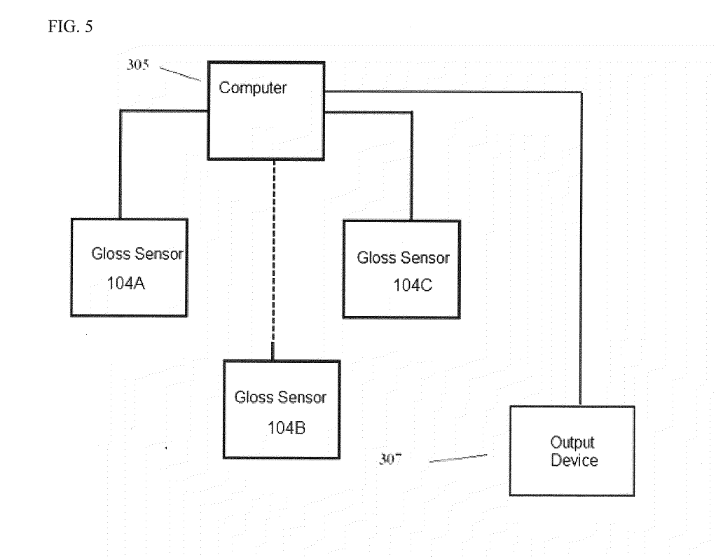

The present device is also equipped with a plurality of pickup sensors 104A, 104B, 104C azimuthally arranged about the normal (perpendicular direction) of the sample to be measured. Each of the pick-up sensors are configured to output a signal value corresponding the amount of illumination that is incident upon the sensor(s). In the illustrated configuration there are three pairs of illuminants and sensors, but those skilled in the art will appreciate that addition of sensors/illumination pairs can allow for increased azimuthal-angle resolution for the review of the sample. The gloss sensors 104A-C are conventional gloss sensors configured to measure specular reflection of the incident light on the surface of the sample 108. Each gloss sensor 104A-C, upon capturing variable intensity light incident off the sample 108, outputs the light as a sample channel value. The sample channel output is then directed to a light measuring device or computer 305 (see FIG. 5).

In the depicted embodiment, the output is accomplished via electrical transduction through light detectors 305 at the ends of three collimating pickup tubes 304. In an alternative arrangement, the light could further be made to pass through fiber optic cables before reaching the light detectors. Each light detector converts a sample-channel outputs into a raw measured gloss value for storage in a storage medium or for display on a display device.

In one potential arrangement, the gloss sensors 104A-C are positioned within pick-up modules 110A-C. The pickup modules are configured to accept the specular reflection of light off the surface of the sample 108 and direct that light through the pick-up assembly to the sensor.

In another arrangement of the illustrated elements, the illumination and gloss measurement assemblies are configured as modular elements, thus allowing for easy manufacture or configuration. Furthermore, the individual gloss sensor elements 104 and light elements 102 are configurable as removable modules that are separately attached to the measurement device by cables or conduits.

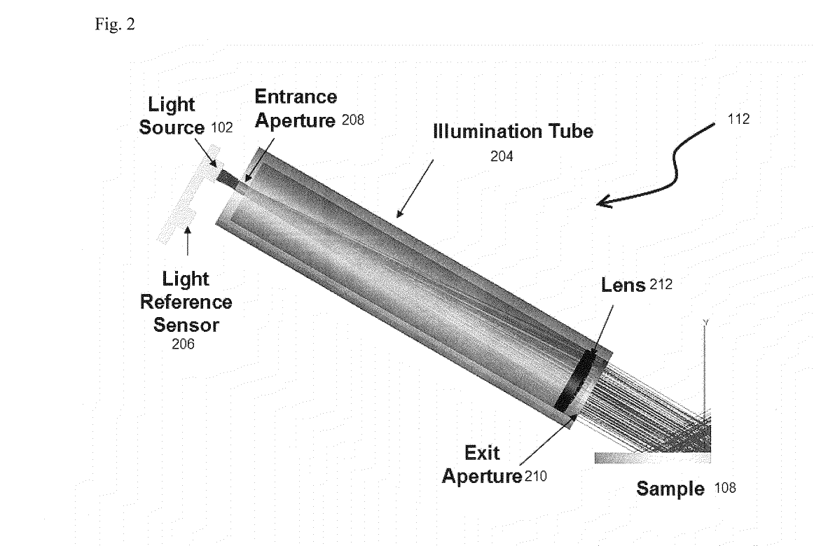

As seen in FIG. 2, the light source 102 is paired with an illumination assembly 112 configured to condition the light directed to the sample 108. As shown, the illumination assembly includes an illumination tube 204. Light from the light source 102 is directed into the illumination tube 204 though an entrance aperture 208. The illumination tube 204 is configured to absorb light rays not directed along the axis of the illumination tube. Light that is directed along the axis of the tube exits the illumination tube 204 at an exit point, such as an exit aperture 210. In one configuration, the illumination tube 204 is equipped with a lens 212 to collimate the illumination to increase the fraction of light that is incident upon the sample 108. In a further arrangement, the light tube is configured to allow the manual or automatic adjustment of the angle of illumination striking the sample 108.

The illumination assembly 112 is also equipped with a reference sensor 206. Regardless of the type of light source 102 used, the light beam generated by the light source lacks uniform intensity over time. This variation in intensity can be the result of numerous factors like thermal drift, voltage fluctuation, current fluctuation, mechanical movement and air pressure differentials. Therefore, the illumination reference sensor 206 is provided to assist in analysis of light that is not incident upon the sample 108. By measuring light simultaneously from the same source, but reflected from a surface other than the sample, the light so measured can be used to cancel time variations of the illumination beam in any resulting calculations. The light sensor 206 is a commonly available sensor capable of generating an output signal that corresponds to the amount of light energy incident upon the surface of the sensor.

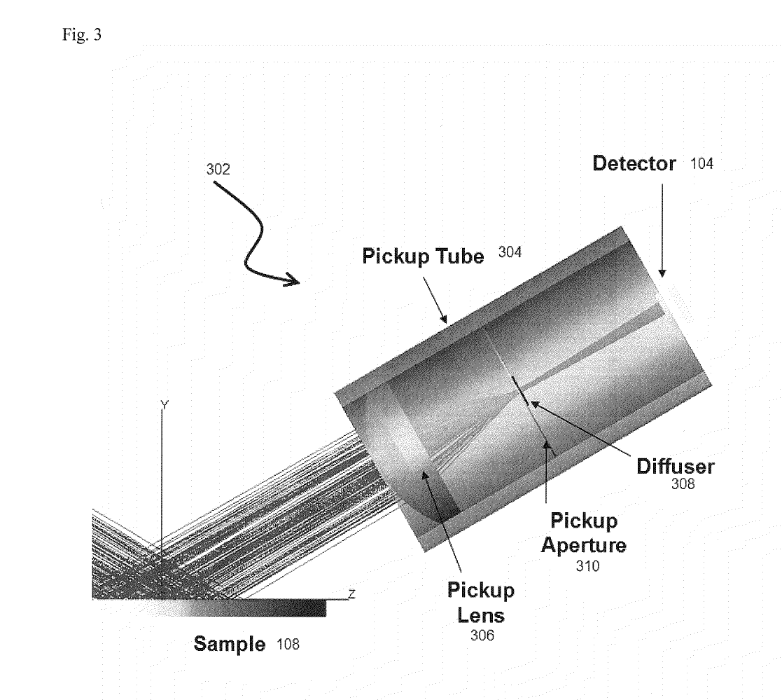

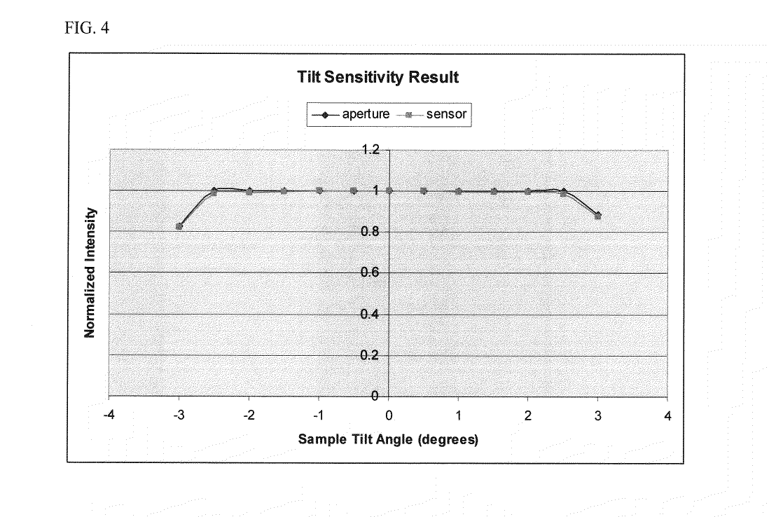

As seen in FIG. 3, the gloss sensor 104 is provided, in one arrangement, with a sensor assembly 302 designed and configured to condition the light that is reflected off the surface of the sample 108 and directed to the sensor 104. The sensor assembly 302 includes a sensor tube 304, or pick-up tube. The pick-up tube 304 is arranged such that the gloss sensor 104 is positioned at the end farthest from the sample 108. In one arrangement of elements, the pickup tube 304 is equipped with a lens 306 designed to focus light incident upon the sample 108 and direct it to a diffuser 308 positioned within the pick-up assembly. The diffuser 308 is positioned at the focal point of the lens 306. The diffuser 308 is configured to spread the light beam so that a uniform cross section of light is incident upon the gloss sensor 104. A pickup aperture 310 is configured to cooperate with the diffuser to provide tilt tolerance to the sample 108, as graphed in FIG. 4. In one arrangement, the pick-up tube 304 is not equipped with an aperture 310 and a diffuser 308 and the light from the lens 306 is focused directly onto the sensor 104. However, in the alternative, if the sample 108 has tilt, or the sensor detection area is difficult to focus on, the aperture 310 and diffuser 308 provide greater measurement tolerance.

Once the reflected light is incident upon the gloss sensor 104, the sensor 104 is configured to output a signal to a processor 305, together with the output of the reference sensor 206 so a ratio can be effected that cancels the time variation of the light. The sensors are configured to output the generated signal to the processor 305 is configured as a transferable communication link. For example, data is transferred through an electrical, wireless or fiber-optic communication linkage.

Those skilled in the art will appreciate the various computational mechanisms available to computer 305 for obtaining a calibrated gloss value from data channel inputs, for example by placing at the sample location a material such as a black glass and then scaling the subsequent gloss measurements of the device to replicate a tabulated value for the gloss of the black glass.

The computer 305 compares the illumination reference channels and the gloss channel signals in order to compensate for light source fluctuations in time (which might be due to temperature dependencies such as in LED illuminators). The corrected value is displayed as an output device 307. Alternatively, the computer 305 is configured to store the values of the compensated measurement and uncompensated measurement for later statistical or analytical investigation in a database. In a further alternative arrangement, the computer 305 is configured to trigger an alarm when a determined compensation factor value reaches a certain threshold. In an alternative configuration the trigger for an alarm is a signal generated from the computer that is related to the value of the ratio of the illumination channel value to gloss measurement channel value.

As seen in FIG. 5, the computer 305 processes the information from the sensors to determine gloss values using widely understood algorithms. For instance, the computer 305 is equipped perform statistical analysis on multiple readings of the signal channel data.

It is further expected that the computer 305 is fully capable of connecting to external and internal networks so as to distribute processing tasks or exchange data related to each slide. The computer 305 is configured to connect to networks and databases using commonly understood programming interfaces and interface modules, e.g., Media Server Pro, Java, Mysql, Apache, and other similar application programming interfaces and database management solutions. The illustrated computer system 305 is characterized, in part, by its broad adaptability to user configurations, multiple user inputs, and hardware configurations.

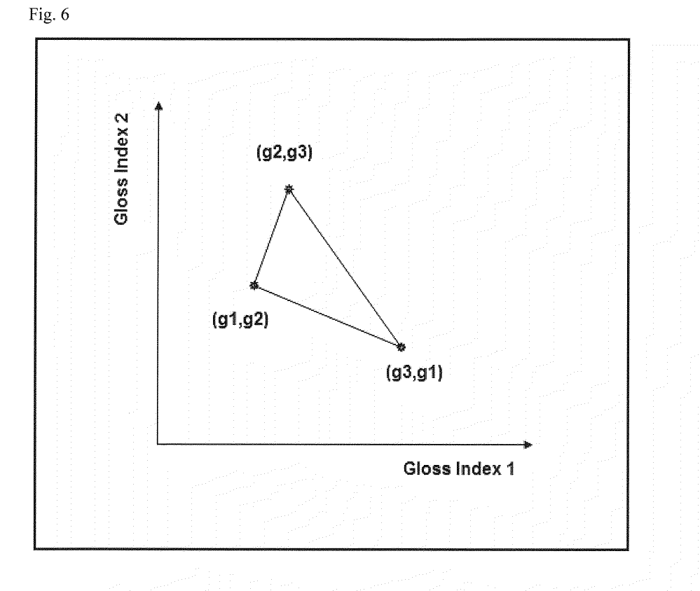

As seen in FIG. 6, the computer 305 is further configured to accept measured gloss values g1, g2 and g3 as gloss values from their respective gloss sensors, compensated for the illumination value, and plot calculated values for display to a user. With the generated and compensated gloss measurements from a plurality of illumination orientations, the computer 305 is configured to generate a plurality of gloss index pairs, for example (g1, g2), (g2, g3) and (g3, g1). The index pairs are plotted in the x-y plane with the first index in the pair as the x coordinate and the second one as the y coordinate. As a result, the plot in FIG. 6 is obtained.

The plot as provided in FIG. 6 is configurable such that it is stored by the computer memory for further analysis, provided to a user for visual analysis, or stored in a database for further review and analysis. In all uses, the resulting index-pair plot is used to indicate the surface texture of the sample. If the sample is isotropic, the triangle should shrink to a point. On the other hand, if the sample is anisotropic, then the three points separate from each other and form a triangle. The bigger differences the three gloss values have, the larger the area of the triangle will be. The processor is configured to automatically calculate the area of the resulting triangle and use that value as an index of the anisotropy of the sample surface. An overall or average gloss value for the sample in question can also be computed. It should be noted that the center of the triangle can be used to represent that overall-gloss number, for example, using the formula: (⅓) (g1+g2+g3).

The present invention also incorporates a sequence of steps for using the system so described to carry out and achieve the function of providing a calibrated gloss value of a surface to a display or storing the calibrated gloss value for later retrieval. Such a method involves, but is not limited to an instrument selection step, in which the settings, such as the tilt/angle of the sensor modules, the illumination frequency, and the number of illuminant/sensor pairs are selected and positioned.

The method includes a calibrating step such that a calibration calculation is performed on each of the gloss-meter channels so as to provide proper calibration values. A measuring step is also provided, wherein the signal from each of the active gloss sensors is obtained. A calculating step is also provided in order determine the directional gloss values, a metric of their dispersion, and an average of them.

The calculating step may be configured as a series of sub modules designed to carry out specific steps performing the functions described. For example, a sub module is provided for determining a metric for the agreement of three measurements (a, b, c) from a three-channel azimuthally arranged gloss meter. That metric is the area of the triangle with vertices (a, b), (b, c), and (c, a). In one example, this area is calculated as is provided in Equation (1).

$$\begin{matrix}A = ( 1 / 2 ) det \vert ( c - a ) , ( b - a ) ; ( a - b ) , ( c - b ) \vert \\ = ( 1 / 2 ) [ ( c - a ) ( c - b ) - ( b - a ) ( a - b ) ] \\ = ( 1 / 2 ) ( {a}^{2} + {b}^{2} + {c}^{2} - ab - bc - ac ) \\ = ( 1 / 4 ) [ {( a - b )}^{2} + {( b - c )}^{2} + {( a - c )}^{2} ] .\end{matrix} \qquad ( 1 )$$

The last line of Formula 1 reveals that A is a scaled sum-square differences among a, b, and c.

Under this calculation module example, A is ¼ the sum of the squares of the differences among all the elements a, b, c. An equivalent sub-module is likewise configurable to output the calculated metric as a sum of square differences, and also as a statistical variance value, v, of the three numbers a, b, c. By setting the value of the mean such that mean m=(a+b+c)/3, the variance computation is thus:

$$\begin{matrix}v = ( 1 / 2 ) \{ {[ a - m ]}^{2} + {[ b - m ]}^{2} + {[ c - m ]}^{2} \} \\ = ( 1 / 2 ) \{ \begin{matrix}{[ a - ( a + b + c ) / 3 ]}^{2} + \\ {[ b - ( a + b + c ) / 3 ]}^{2} + \\ {[ c - ( a + b + c ) / 3 ]}^{2}\end{matrix} \} \\ = ( 1 / 6 ) [ {( a - b )}^{2} + {( b - c )}^{2} + {( a - c )}^{2} ]\end{matrix} \qquad ( 2 )$$

Comparing Formula 2 with Formula 1, it follows that A=3v/2.

Formula 2 also allows the metric to be generalized to ‘n’ number of channels of gloss-meter. In general Formula 3 provides wherein n and measurements aⱼ, j=1, . . . , n:

$$A = {( 3 / 2 ) [ n ( n - 1 ) ]}^{- 1} {\sum }_{j = 1}^{n} {\sum }_{k = 1}^{j - 1} {( {a}_{j} - {a}_{k} )}^{2} , \qquad ( 3 )$$

where the factor [n (n−1)]⁻¹ compensates the number of terms in the sum of squares, and the leading factor 3/2 makes A agree with the n=3 area interpretation above. Note that A=0 if and only if all the elements aⱼ are equal to each other.

This calculation provides for calculation of a quantity analogous to area, independent of n. A as defined above is the same as 3v/2, where v is the variance of the set of aₖ. The present invention provides for an additional sub module to provide the necessary calculation of the desired value. For example, the module calculates the desired value by extending the k sum in Eq. 3 to n, to the following:

$$A = {( 3 / 4 ) [ n ( n - 1 ) ]}^{- 1} {\sum }_{j = 1}^{n} {\sum }_{k = 1}^{n} {( {a}_{j} - {a}_{k} )}^{2} , \qquad ( 4 )$$

Expanding the squared term in the Eq. 4, provides

$$A = {( 3 / 4 ) [ n ( n - 1 ) ]}^{- 1} {\sum }_{j = 1}^{n} {\sum }_{k = 1}^{n} ( {a}_{j}^{2} - {a}_{k}^{2} - 2 {a}_{j} {a}_{k} ) . \qquad ( 5 )$$

Furthermore, by denoting the mean of aⱼ by

$$m = ( 1 / n ) {\sum }_{k = 1}^{n} {a}_{k} . \qquad ( 6 )$$

Eq. 6 becomes

$$\begin{matrix}A = {( 3 / 4 ) [ n ( n - 1 ) ]}^{- 1} {\sum }_{j = 1}^{n} {\sum }_{k = 1}^{n} ( {a}_{j}^{2} - {a}_{k}^{2} - 2 {a}_{j} {a}_{k} ) \\ = {( 3 / 4 ) [ n ( n - 1 ) ]}^{- 1} [ 2 n {\sum }_{j = 1}^{n} {a}_{j}^{2} - 2 {\sum }_{j = 1}^{n} {a}_{j} {\sum }_{k = 1}^{n} {a}_{k} ) \\ = ( 3 / 2 ) {( n - 1 )}^{- 1} {\sum }_{j = 1}^{n} ( {a}_{j}^{2} - {nm}^{2} ) .\end{matrix} \qquad ( 5 )$$

Since

$${( n - 1 )}^{- 1} {\sum }_{j = 1}^{n} ( {a}_{j}^{2} - {nm}^{2} )$$

is an alternative computational form of the variance v (see P. G. Hoel, Elementary Statistics, 2^{nd} ed, Wiley, 1966, p. 37), we have now shown that, in general,

A=3v/2. (6)

Thus, the calculations of the described module provides that the triangular-area metric of disagreement among three measurements is generalized to n measurements aⱼ as (3/2) [n (n−1)]⁻¹ times the sum of the square differences between each of the measurement pairs. This metric in turn, is 3/2 the variance of the measurements aⱼ.

These calculations can then be output by an output module. The output module can be configured as a series of discrete sub-modules designed to provide functionality to the present invention of resolving the measurements of n gloss meters to provide a gloss value for the overall sample. The discrete sub-modules can include instructions for combining the compensated gloss value and formatting the value for display on a particular display device or for updating a database of reference values and stored values.

Each of these modules can comprise hardware, code executing in a processor, or both, that configures a machine such as the computing system to implement the functionality described herein. The functionality of these modules can be combined or further separated, as understood by persons of ordinary skill in the art, in analogous implementations of embodiments of the invention.

It should be understood that various combination, alternatives and modifications of the present invention could be devised by those skilled in the art. The present invention is intended to embrace all such alternatives, modifications and variances that fall within the scope of the appended examples.

While the invention has been particularly shown and described with reference to a preferred embodiment thereof, it will be understood by those skilled in the art that various changes in form and details may be made therein without departing from the spirit and scope of the invention.

What is claimed:

1. An apparatus for determining a set of gloss measurement values of a sample to be measured comprising:
a plurality of light sources having a light output, the plurality of sources configured to project light in the direction of a single sample having a gloss characteristic to be measured, wherein the planes of incidence of the light sources are arrayed at different azimuthal angles about the perpendicular direction of the sample;
a plurality gloss-sensitive sensors, each positioned at 180 degrees of azimuthal angle from the plurality of light sources so as to receive light reflected off a sample and output a plurality of measured gloss sample channel values; and
a processor configured to compare the outputs of the plurality of sample channel values and generate a plurality of angle-indexed gloss measurement values for the sample that are substantially free of variations of the activated light sources, wherein the processor is further configured to output the plurality of angle-indexed gloss measurement values to a user.

2. The apparatus for determining the set of gloss measurement values of claim 1, wherein each light source is equipped with a reference channel sensor configured to calibrate variations of the light output over time not due to physical properties of the sample.

3. The apparatus for determining the set of gloss measurement values of claim 1, wherein the processor is further configured to connect to an alarm and a database, wherein the alarm is activated by a trigger signal generated by the processor.

4. The apparatus for determining the set of gloss measurement values of claim 3, wherein the database is configured to store a range of angle-indexed gloss measurement reference values.

5. The apparatus for determining the set of gloss measurement values of claim 4, wherein the processor is further configured to compare the stored reference values with sample derived gloss measurement values and generate the trigger signal to activate the alarm when the derived gloss measurement values are outside of the range.

6. The apparatus for determining the set of gloss measurement values of claim 2, wherein the light source is equipped with a light tube and lens configured to direct and focus light output traveling along the axis of the light tube to the sample.

7. The apparatus for determining the set of gloss measurement values of claim 2, wherein the plurality of gloss sensors are equipped with sensor tubes, each configured with a lens, a diffusion screen and an aperture.

8. A computer-implemented method for utilizing a particular connection with an electronic device in determining a set of gloss characteristics of a sample using a plurality of gloss meters, the particular electronic device having a processor, a memory, an input device, an output device and a calculation application stored in the memory and executable by the processor, the method comprising:
projecting a plurality of light beams onto a sample to be measured, the planes of incidence of the light sources arrayed at different azimuthal angles about the perpendicular direction of the sample;
generating a sample channel value from a plurality of gloss sensors, each positioned at 180 degrees of azimuthal angle so as to receive light from an illumination source;
generating a plurality of angle-indexed gloss measurement values for the sample;
outputting a signal to the output device.

9. The method according to claim 8, further comprising the step of:
triggering a human perceptible alarm when the output signal is generated, wherein the alarm has an audio, visual, or a combination of both audio-visual characteristics.

10. The method according to claim 8, further comprising the step of:
generating for each channel a light reference channel value from a light source reference sensor wherein the light reference channel value is related to the variation in the light projected onto the sample; and
comparing the sample channel value of each gloss sample channel to its corresponding reference channel value and determining a corrected gloss reference channel value using the processor by executing the compensation application so as to compensate the light-intensity variations in each gloss sample channel.

11. The method according to claim 8, further comprising the step of:
comparing the set of angle-indexed gloss values to a set of reference gloss measurement values stored in the memory; and
triggering an alarm when the values of the angle-indexed set exceed those of the reference set.

12. A method for determining a set of gloss characteristics of a sample using a plurality of gloss meters, the method comprising:
projecting a plurality of light beams from a plurality of light sources onto a sample to be measured, the planes of incidence of the light sources arrayed at different azimuthal angles about the perpendicular direction of the sample;
generating a sample channel value from a plurality of gloss sensors, each positioned at 180 degrees of azimuthal angle so as to receive light from an illumination source;
generating a plurality of angle-indexed gloss measurement values for the sample;
outputting a signal to an output device.

13. The method of claim 12, further comprising:
Storing the output signal to a storage device.

14. The method of claim 14, further comprising:
accessing at least one of a plurality of output signals stored in a storage device;
comparing to the signal outputted to the storage device; and
triggering an indicator to a user based on the results of the comparison of the stored signal and the outputted signal.

15. The method of claim 12, further comprising:
determining a metric for the agreement of a plurality of measurements from the multi-channel azimuthally arranged gloss meter.

16. The method of claim 15, wherein the metric is the area of a polygon with vertices corresponding to the ordered pairs of the plurality of measurement values.

17. The method of claim 15, further comprising:
outputting to a display device, at least the calculated metric as a sum of square differences of the measurement values and the statistical variance value of the measurement values.

18. The method of claim 15, wherein the metric is calculated according to:
$$A = {( 3 / 2 ) [ n ( n - 1 ) ]}^{- 1} {\sum }_{j = 1}^{n} {\sum }_{k = 1}^{j - 1} {( {a}_{j} - {a}_{k} )}^{2} ,$$
and n=the number of gloss channels and wherein n and measurements aⱼ, j=1, . . . , n.
